(19) United States
(12) Patent Application Publication
(10) Pub. No.: US 2011/0052344 A1
(43) Pub. Date: Mar. 3, 2011

(54) NUT WITH LOCKING ASSEMBLY, AND DEVICE USING SAME

(75) Inventor: BAO-QIN XU, Shenzhen City (CN)

(73) Assignees: HONG FU JIN PRECISION INDUSTRY (ShenZhen) Co., LTD, Shenzhen City (CN); HON HAI PRECISION INDUSTRY CO., LTD., Tu-Cheng (TW)

(21) Appl. No.: 12/710,370

(22) Filed: Feb. 23, 2010

(30) Foreign Application Priority Data
Aug. 25, 2009 (CN) 200910306049.9

(51) Int. Cl. F16B 39/00; F16B 37/08

(52) U.S. Cl. 411/259; 411/432

(57) ABSTRACT

A nut capable of being used to engage with a bolt includes a hollow body and a plurality of fastening structures rotatably fixed to the hollow body. Each fastening structure includes a fastening member including a connecting part, an internally threaded part, and a pressable part. The connecting part is received in the hollow body and rotatably fixed to the hollow body. The internally threaded part is connected to one end of the connecting part. The pressable part is connected to the other end of the connecting part. When the pressable part of the fastening member is pressed, the connecting part is rotated relative to the hollow body accordingly, so as to cause the internally threaded part of the fastening member to engage with the bolt.

### BACKGROUND

1. Technical Field

The present disclosure relates to nuts and particularly, to a nut with a locking assembly used for locking to a device.

2. Description of Related Art

In the process of assembling members to a device, locking assemblies, including nuts and bolts, are used as fastening members. However, to screw and unscrew a nut from the corresponding bolt will depend on the length of the bolt that sticks out from the assembly.

Therefore, there is room for improvement in the art.

### BRIEF DESCRIPTION OF THE DRAWINGS

The components of the drawings are not necessarily drawn to scale, the emphasis instead being placed upon clearly illustrating the principles of the embodiments of a nut used for a locking assembly and a device. Moreover, in the drawings, like reference numerals designate corresponding parts throughout several views.

FIG. 1 is an isometric view of a nut used for a locking assembly and a device, according to an exemplary embodiment.

FIG. 2 is an exploded view of the nut of FIG. 1.

FIG. 3 is a schematic, cross-sectional view of the locking assembly with the nut of FIG. 1.

FIG. 4 is an isometric view of the device with the nut of FIG. 1.

FIG. 5 is a schematic, cross-sectional view of the device with the nut of FIG. 1 in a first state.

FIG. 6 is similar to FIG. 5, but showing the device in a second state.

FIG. 7 is similar to FIG. 5, but showing the device in a third state.

### DETAILED DESCRIPTION

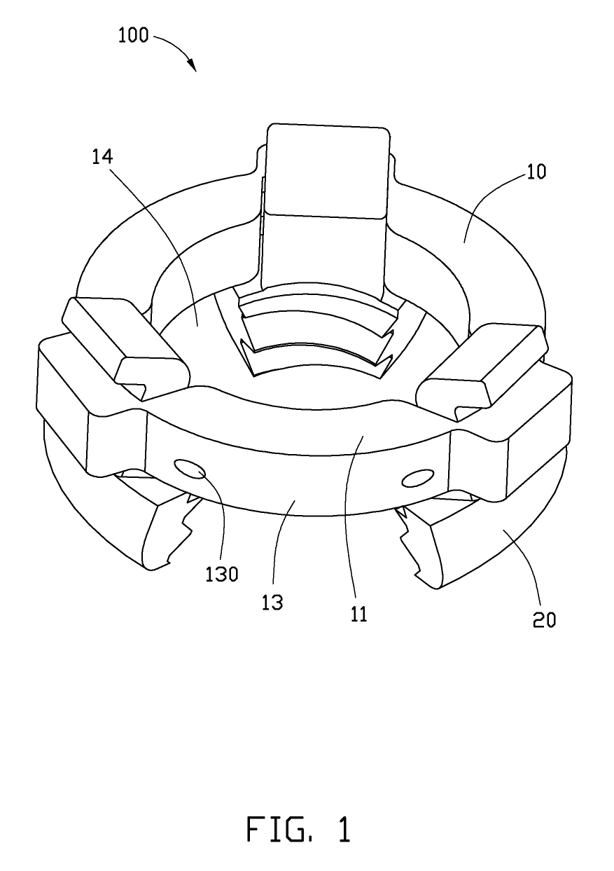

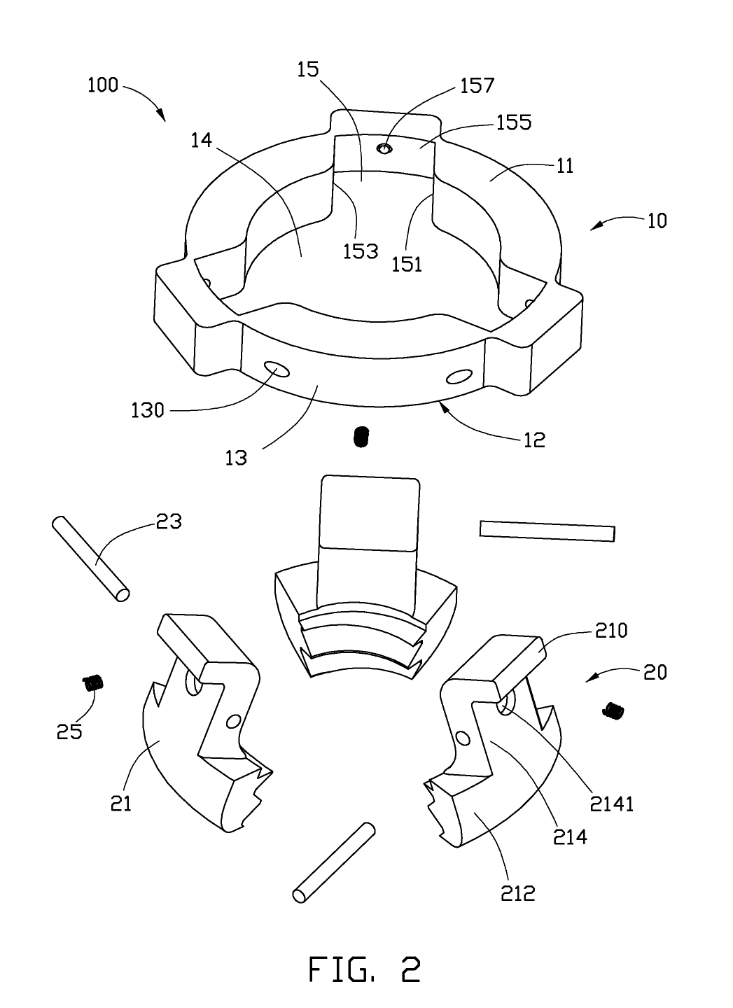

Referring to the FIGS. 1 and 2, a nut 100 in accordance with one embodiment is illustrated. The nut 100 includes a hollow body 10 and three fastening structures 20.

The body 10 is substantially sleeve-shape, and includes a side wall 13. An opening 14 is enclosed by the side wall 13. The side wall 13 includes two opposite end surfaces 11, 12. Three recesses 15 are defined in an inner surface of the side wall 13 at an equal interval. The three recesses 15 are configured for receiving the three fastening structures 20 correspondingly. Each recess 15 runs through the two end surfaces 11, 12, and communicates with the opening 14. Each recess 15 defines a first surface 151, a second surface 153 opposite to the first surface 151, and a third surface 155 which defines a first receiving recess 157 connected to the first surface 151, and the second surface 153. Three pairs of first holes 130 are defined running through the side wall 13. Each pair of first holes 130 is opposite one of the three recesses 15, and communicates with the corresponding recess 15.

The three fastening structures 20 are received in the three recesses 15 correspondingly and are rotatably fixed to the side wall 13. The three fastening structures 20 have a same structure. This embodiment shows one of the three fastening structures 20 described in detail. The fastening structure 20 includes a fastening member 21, a rotating shaft 23, and an elastic member 25. The fastening member 21 includes a pressable part 210, an internally threaded part 212, and a connecting part 214.

The pressable part 210 is received in the recess 15. The pressable part 210 perpendicularly extends from one end of the connecting part 214, and the internally threaded part 212 straightly extends from the other end of the connecting part 214. A second receiving recess 2141 is defined in the connecting parts 214 and corresponds to the first receiving recess 157.

The rotating shaft 23 passes through the pair of first holes 130 and the connecting part 214 to be rotatably fastened the side wall 13, correspondingly. One end of the elastic member 25 is received in the first receiving recess 157, and the other end of the elastic member 25 is received in the second receiving recess 2141. In this embodiment, the elastic member 25 is a spring. In other embodiments, the elastic member 25 can be made of rubber.

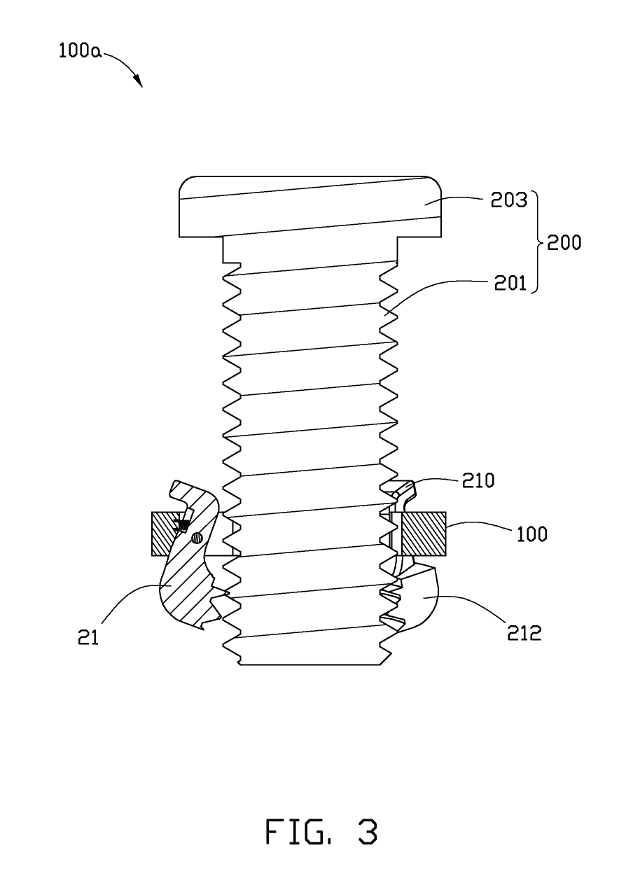

Referring to the FIG. 3, a locking assembly 100a is illustrated. The locking assembly 100a includes the nut 100 and a bolt 200. The bolt 200 includes an externally threaded portion 201 and a head portion 203. The externally threaded portion 201 extends from the head portion 203 and passes through the opening 14. The nut 100 is used to engage with the bolt 200 (as described below).

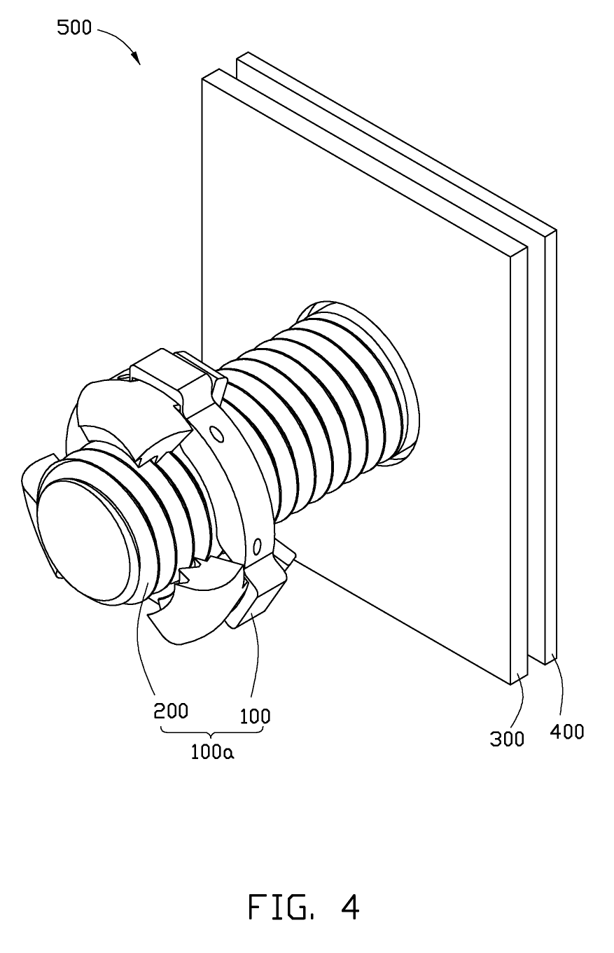

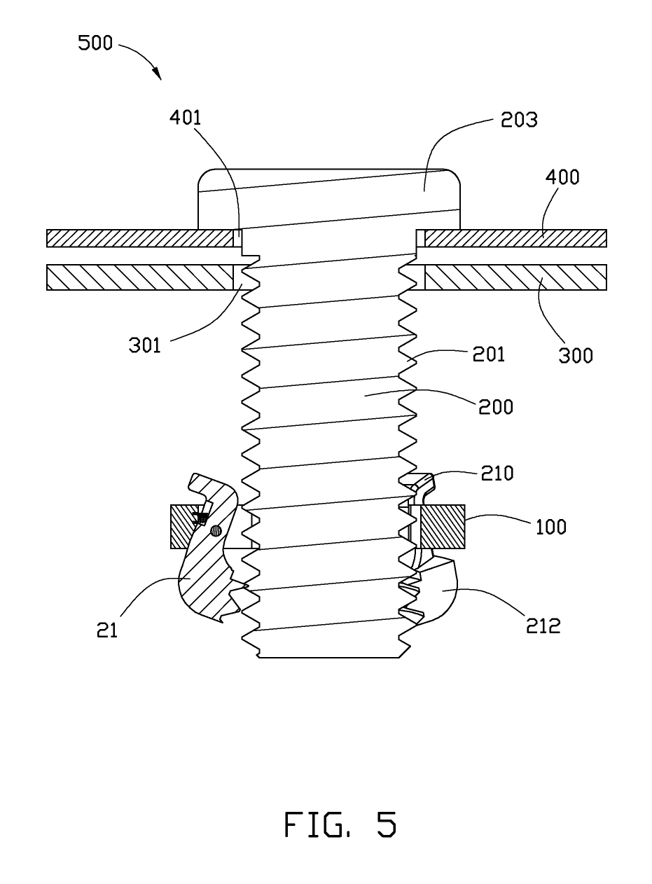

Further referring to the FIG. 4, a device 500 is illustrated. The device 500 includes the locking assembly 100a, a first component 300, and a second component 400. The locking assembly 100a is used for fastening the first component 300 to the second component 400. Referring to the FIG. 5, a second hole 301 is defined in the first component 300. A third hole 401 is defined in the second component 400. The bolt 200 successively passes through the third hole 401, the second hole 301, and the opening 14 to match the nut 100. The three nut components 20 are loose with the bolt 200 (as shown in a first state of FIG. 5)

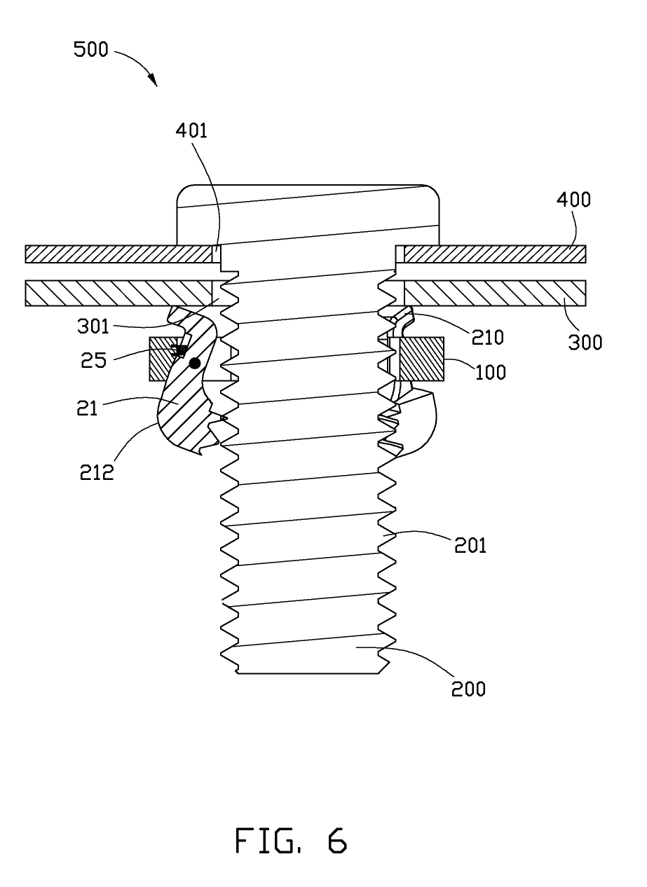

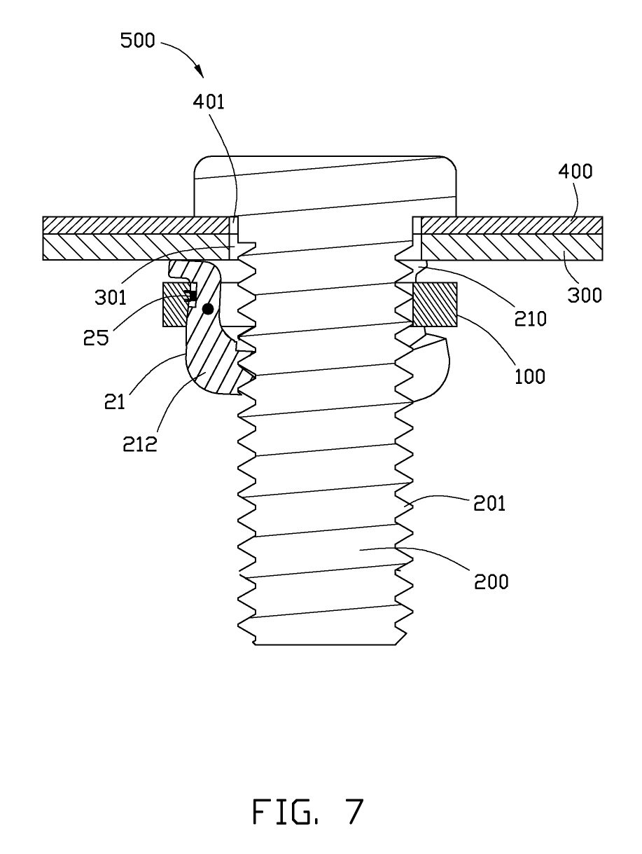

Referring to the FIG. 6, the two pressable parts 210 of the nut 100 are resisted with the first component 300 when the nut 100 contacts with the first component 300 (as shown in a second state of FIG. 6). Further referring to the FIG. 7, the three connecting parts are rotated relative to the hollow body 10 accordingly, so as to cause the two internally threaded parts of the fastening member 21 to engage with the bolt 200, and the elastic member 25 is deformed. When the nut 100 is rotated, the three internally threaded parts 212 are together engaged with the bolt 200 as a common way to fasten the first component 300 and the second component 400 (as shown in a third state of FIG. 7). Therefore, the device 500 is fastened by the nut 100 and the bolt 200 of the locking assembly 100a. In the fastening process of the locking assembly 100a, the more pressure of the three pressable parts 210, the greater fastening ability of the locking assembly 100a, the stronger the elasticity of the three elastic members 25. As the bolt 200 needs not to be threaded with the nut 100 step by step, it saves time for the locking assembly 100a fastening the first component 300 and the second component 400 of the device 500.

As described, the three fastening structures 20 are capable of being operated between a normal state and a fastening state. In the normal state, the three fastening structures 20 are in association with the hollow body 10 and are capable of being freely moved from a distal end of the externally threaded portion 201 to a joint portion where the head portion 203 and the externally threaded portion 201 are connected (as shown in the first state of FIG. 5). In the fastening state, the three fastening structures 20 are pressed by either the first component 300 or the second component 400 to rotate relative to the hollow body 10. The three internally threaded parts 212 engage with the externally threaded portion 201 for fastening the first component 300 and the second component 400 together (as shown in the second state of FIG. 6 and the third state of FIG. 7). In other embodiments, the number of the internally threaded part 212 can be two or more than three. As the three internally threaded parts 212 are rotatably fixed on the hollow body 10, a diameter of the nut 100 can be adjustable to fit different size bolts.

When the nut 100 rotates in a reverse direction, a lighter pressure is put on the three pressable parts 210; the fastening ability of the locking assembly 100a is lessened. As well as the elasticity of the three elastic members 25, the locking assembly 100a resets, and the three internally threaded parts 212 is not firmly attached to the bolt 200 any more. Thereby, the first component 300 is separated from the second component 400. As the nut 100 does not need to be fully unthreaded from the bolt 200, it saves time for releasing the locking assembly 100a from the first component 300 and the second component 400 of the device 500.

It is to be understood, however, that even though numerous has been described with reference to particular embodiments, but the present disclosure is not limited to the particular embodiments described and exemplified, and the embodiments are capable of considerable variation and modification without departure from the scope of the appended claims.

What is claimed is:

1. A nut capable of being used to engage with a bolt, the nut comprising:
a hollow body; and
a plurality of fastening structures rotatably fixed to the hollow body, each fastening structure comprising a fastening member, each fastening member comprising:
a connecting part received in the hollow body and rotatably fixed to the hollow body;
an internally threaded part connected to one end of the connecting part; and
a pressable part connected to the other end of the connecting part, while the pressable part of the fastening member is pressed, the connecting part is rotated relative to the hollow body accordingly, so as to cause the internally threaded part of the fastening member to engage with the bolt.

2. The nut of claim 1, wherein the internally threaded part straightly extends from one end of the connecting part.

3. The nut of claim 1, wherein the pressable part perpendicularly extends from the other end of the connecting part.

4. The nut of claim 1, wherein the hollow body comprises a side wall, an opening is defined by the side wall, the side wall comprises two opposite end surfaces, a plurality of recesses is defined in an inside surface of the side wall for receiving the plurality of connecting parts correspondingly, each recess runs through the two end surfaces and communicates with the opening.

5. The nut of claim 4, wherein each recess defines a first surface, a second surface opposite to the first surface, and a third surface connected the first surface and the second surface, each fastening structure further comprises a rotating shaft, the rotating shaft runs through the side wall and the connecting part to rotatably connect with the first surface and the second surface correspondingly.

6. The nut of claim 5, wherein a plurality of first receiving recesses is defined in the plurality of third surfaces, a plurality of second receiving recesses is defined in the plurality of connecting parts corresponding to the plurality of first receiving recesses, each fastening structure further comprises an elastic member, one end of the elastic member is received in the first receiving recess, and the other end of the elastic member is received in the second receiving recess, correspondingly.

7. The nut of claim 6, wherein the plurality of elastic members is deformed when the plurality of pressable parts is pressed, elasticity of the plurality of elastic members forces the plurality of internally threaded parts to reset when the pressure of the plurality of pressable parts is removed.

8. The nut of claim 1, wherein the plurality of fastening structures is rotatably fixed in the hollow body at an equal interval.

9. The nut of claim 6, wherein the plurality of elastic members is selected from a spring or a rubber.

10. A locking assembly capable of fastening a first component with a second component, the locking assembly comprising:
a bolt comprising:
a head portion; and
an externally threaded portion extending from the head portion; and
a nut capable of screwing with the bolt, the nut comprising:
a hollow body defining an opening for the externally threaded portion extending there through; and
a plurality of fastening structures rotatably mounted to the hollow body, each fastening structure arranged with an internally threaded part;
wherein the plurality of fastening structures is capable of being operated between a normal state and a fastening state; in the normal state, the plurality of fastening structures in association with the hollow body is capable of being freely moved from a distal end of the externally threaded portion to a joint portion where the head portion and the externally threaded portion are connected, and in the fastening state, the plurality of fastening structures is capable of being pressed by either the first component or the second component to rotate relative to the hollow body, such that the internally threaded part is engaged with the externally threaded portion for fastening the first component and the second component together.

11. The locking assembly of claim 10, wherein each fastening structure comprises a fastening member, each fastening member is arranged with the internally threaded part and further comprises:
a connecting part received in the hollow body and rotatably fixed to the hollow body, one end of the connecting part connected to the internally threaded part; and
a pressable part connected to the other end of the connecting part, while the pressable part of the fastening member is pressed, the connecting part is rotated relative to the hollow body accordingly, so as to cause the internally threaded part of the fastening member to engage with the bolt.

12. The locking assembly of claim 11, wherein the internally threaded part straightly extends from one end of the connecting part.

13. The locking assembly of claim 11, wherein the pressable part perpendicularly extends from the other end of the connecting part.

14. The locking assembly of claim 11, wherein each fastening structure further comprises an elastic member, one end of the elastic member is connected to the connecting part, the other end of the elastic member is connected with the hollow body, the elastic member is deformed when the pressable part is pressed, elasticity of the elastic member forces the internally threaded part to reset when the pressure of the plurality of pressable parts is removed.

15. A device, comprising:
a first component;
a second component mounted on the first component;
an externally threaded bolt passing through the first component and the second component; and
a nut comprising a plurality of internally threaded parts, while the nut is capable of being pressed by either the first component or the second component, the plurality of internally threaded parts of the nut is engaged with the externally threaded bolt for fastening the first component and the second component together.

16. The device of claim 15, wherein the nut further comprises:
a hollow body defining an opening for the externally threaded bolt extending there through; and
a plurality of fastening structures rotatably mounted to the hollow body, each fastening structure arranged with the internally threaded part;
wherein the plurality of fastening structures is capable of being operated between a normal state and a fastening state; in the normal state, the plurality of fastening structures in association with the hollow body is capable of being freely moved to touch either the first component or the second component, and in the fastening state, the plurality of fastening structures is capable of being pressed by either the first component or the second component to rotate relative to the hollow body, such that the internally threaded part is engaged with the externally threaded bolt for fastening the first component and the second component together.

17. The device of claim 16, wherein each fastening structure comprises a fastening member, each fastening member is arranged with the internally threaded part and further comprises:
a connecting part received in the hollow body and rotatably fixed to the hollow body, one end of the connecting part connected to the internally threaded part; and
a pressable part connected to the other end of the connecting part, while the pressable part of the fastening member is pressed, the connecting part is rotated relative to the hollow body accordingly, so as to cause the internally threaded part of the fastening member to engage with the externally threaded bolt

18. The device of claim 17, wherein the internally threaded part straightly extends from one end of the connecting part.

19. The device of claim 17, wherein the pressable part perpendicularly extends from the other end of the connecting part.
